(19) United States
(12) Patent Application Publication
(10) Pub. No.: US 2018/0367478 A1
(43) Pub. Date: Dec. 20, 2018

(54) USER INTERFACE WITH SIDEWALK FEED

(71) Applicant: Microsoft Technology Licensing, LLC, Redmond, WA (US)

(72) Inventor: Patrick Desjardins, Redmond, WA (US)

(21) Appl. No.: 15/625,214

(22) Filed: Jun. 16, 2017

(51) Int. Cl. H04L 12/58

(52) U.S. Cl. CPC H04L 51/04; G06F 3/0482

(57) ABSTRACT

Non-limiting examples of the present disclosure relate to enhanced user interface that provides a dual message feed for viewing and simultaneously managing a message thread. A dual feed may be a multi-column feed for the message thread that may be displayed through a user interface, for example, in response to a selection of the message thread. The multi-column feed may comprise: a first column that provides a summary feed providing summary data associated with message content of the message thread and a second column that provides a sidewalk feed presenting an entire representation for message content of the message thread. An update to the message thread may be received. A display of the message thread may be updated through the user interface, for example, where the first column of the multi-column feed is configured to present a real-time notification of the update.

### BACKGROUND

Message feeds are provided in user interfaces to provide a user with an ability to manage message content for collaboration with other users. A message feed provides notifications for a list of messages that come with a composed time. The problem with a typical message feed of information is that it shows too little information, which requires the user to click on an item to move where the whole conversation is or to display the whole thread collapsed in the feed. When a user selects to view a specific message, the user is moved into the thread of the message and the user is moved out of the message feed. If an update occurs to the message thread, the user does not receive the update until the user takes action to move back to the message feed (and out of the message thread).

In alternate examples, a message feed and a message thread are displayed in a single column representation within a user interface. In such instances, the user is not moved out of the message feed when viewing message content. If an update occurs to the message feed, the update may affect the message feed, distracting the user from viewing specific message content. For instance, a notification received in the message field may re-position the message thread to the newly received content. In other instances, notifications are provided over message content where a user may be forced to acknowledge the notification to return back to viewing of specific message content.

As such, non-limiting examples of the present disclosure pertain to an enhanced user interface that provides a dual feed for viewing and simultaneously managing a message thread.

### SUMMARY

Non-limiting examples of the present disclosure relate to enhanced user interface that provides a dual feed for viewing and simultaneously managing a message thread. As an example, a dual feed is presented as a multi-column representation that presents multiple feeds associated with a message thread. It should be recognized that presentation of a dual feed may vary without departing from the spirit of the present disclosure. For instance, a user interface may be configured to provide the dual feed as a multi-row message feed, multi-window message feed, etc.

A selection of a message thread may be received through a user interface of an application. A multi-column feed for the message thread may be displayed through the user interface, for example, in response to the selection of the message thread. The multi-column feed may comprise: a first column that provides a summary feed providing summary data associated with message content of the message thread and a second column that provides a sidewalk feed presenting an entire representation for message content of the message thread. An update to the message thread may be received. A display of the message thread may be updated through the user interface, for example, where the first column of the multi-column feed is configured to present a real-time notification of the update.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 illustrates an exemplary method related to management of an exemplary dual feed for a message thread with which aspects of the present disclosure may be practiced.

FIG. 2 illustrates a non-limiting processing device view of an exemplary dual feed for a message thread with which aspects of the present disclosure may be practiced.

FIG. 3 is a block diagram illustrating an example of a computing device with which aspects of the present disclosure may be practiced.

FIGS. 4A and 4B are simplified block diagrams of a mobile computing device with which aspects of the present disclosure may be practiced.

FIG. 5 is a simplified block diagram of a distributed computing system in which aspects of the present disclosure may be practiced.

### DETAILED DESCRIPTION

Non-limiting examples of the present disclosure relate to enhanced user interface that provides a dual feed for viewing and simultaneously managing a message thread. As an example, the dual feed may be a multi-column feed (multi-row message feed, multi-window feed, etc.) for a message thread that may be displayed and managed through a user interface of an application. In examples where the dual feed is a multi-column message feed, the multi-column feed may comprise: a first column that provides a summary feed providing summary data associated with message content of the message thread and a second column that provides a sidewalk feed presenting an entire representation for message content of the message thread. For example, the summary feed may be configured to provide a summary of the context of information within a message thread including recent notification(s) of the message thread. The summary feed is active and continuously changing with incoming new message content. An exemplary sidewalk feed is simultaneously presented with the summary feed where the sidewalk feed is fixed in time and contains previous message content for a user to review in an uninterrupted manner. The sidewalk feed allows the user to read and/or interact (e.g. generate a reply) for the message thread without being interrupted with notifications or changes to the message thread.

Accordingly, the present disclosure provides a plurality of technical advantages including but not limited to an adapted user interface that is configured to improve not only user interaction but also processing efficiency of computing devices that are executing an exemplary application. An exemplary dual feed improves user interaction with an application/service where a user can still receive updates to a message thread in real-time while being interrupted from an action while the user is working within the message thread. Furthermore, examples described herein improve processing efficiency for computing devices that are executing exemplary applications, for example, where multiple applications/excess application windows are not needed nor are extraneous processing operations where users taking manual actions to separately access and management a message feed and content of a message thread. Thus, processing efficiency (e.g., saving computing cycles/computing resources) may be improved for execution of an exemplary application on a computing device. Moreover, examples described herein enhance applications/services, for example, improving application processing by extensibility providing access to and integrating data from different applications/services of a distributed network with the exemplary application/service.

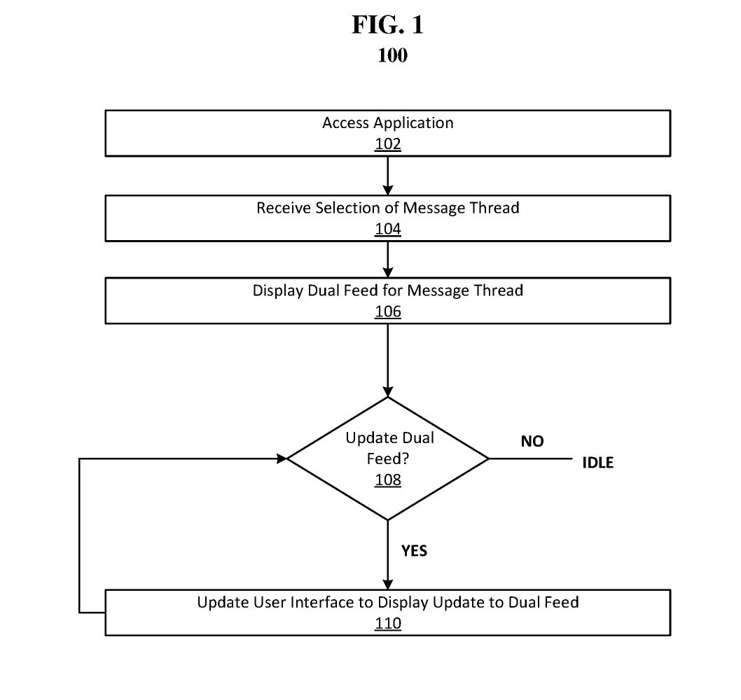

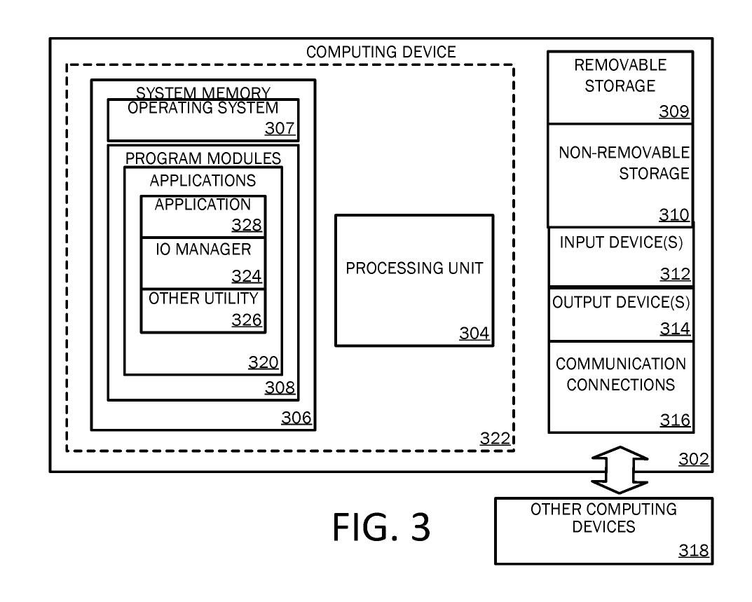

FIG. 1 illustrates an exemplary method 100 related to management of an exemplary dual feed for a message thread with which aspects of the present disclosure may be practiced. As an example, method 100 may be executed by an exemplary processing device and/or system such as those shown in FIGS. 3-5. In examples, method 100 may execute on a device comprising at least one processor configured to store and execute operations, programs or instructions. Operations performed in method 100 may correspond to operations executed by a system and/or service that execute computer programs, application programming interfaces (APIs), neural networks or machine-learning processing, among other examples. As an example, processing operations executed in method 100 may be performed by one or more hardware components. In another example, processing operations executed in method 100 may be performed by one or more software components. In some examples, processing operations described in method 100 may be executed by one or more applications/services associated with a web service that has access to a plurality of application/services, devices, knowledge resources, etc. Processing operations described in method 100 may be implemented by one or more components connected over a distributed network, where an exemplary collaborative team environment may be a distributed service accessed via network connection.

Method 100 begins at processing operation 102, where an exemplary application/service is accessed. For ease of understanding, examples described herein relate to an application/service that is configured as a collaborative team environment. While examples described herein reference a collaborative team environment, it is to be understood that processing operations and user interface examples described herein can extend to any type of application/service that provides message threads which include multiple users. Other such applications/services include but are not limiting to: call communication applications/services, email application/services, chat/instant messaging applications/services, notes applications/services, social networking application/services, documentation tool applications/services, distributed storage applications/services and software development applications/services, among other examples. An exemplary application/service is a collaborative team environment that enables users to communicate collaboratively in teams/groups, for example, on a project by project basis. A collaborative team environment is a team-based groupware solution that helps people work together collectively while located remotely from each other. Collaborative team environments enable real time collaboration synchronously as well as asynchronously. As an example, collaborative team environments can be configured to include functionality such as: multimodal communication, sharing of data including electronic calendars, collective writing messages and communication in message threads, e-mail handling, shared database access, and management of electronic meetings where each user is able to see and display information for others, among other examples. An exemplary collaborative team environment may further be extensible to interface with other applications/services including social networking services and other applications/services associated with a platform (e.g. Microsoft® Office 365® that may provide a suite of applications).

Flow may proceed to processing operation 104, where a selection of a message thread is received. A selection of a message thread may be received (processing operation 104) through a user interface of an exemplary application/service, for example, that is being accessed (processing operation 102). For instance, a user may select a message thread through the application/service. In an alternative example, the application/service is configured to automatically select a message thread for viewing (or multiple message threads) on behalf of a user. For instance, a message thread may be selected for viewing when a user launches an exemplary application/service or when an update is received to a message thread (e.g. where pertinent information is to be presented to a user).

Flow may proceed to processing operation 106, where an exemplary dual feed is displayed for a message thread. A feed is a list of message that come with a composed time. A message can have sub-messages attached. In examples, a main message may start a message thread. The children messages (e.g. of a main message) within a message thread are replies. As an example, the dual feed may be displayed in response to the selection of the message thread.

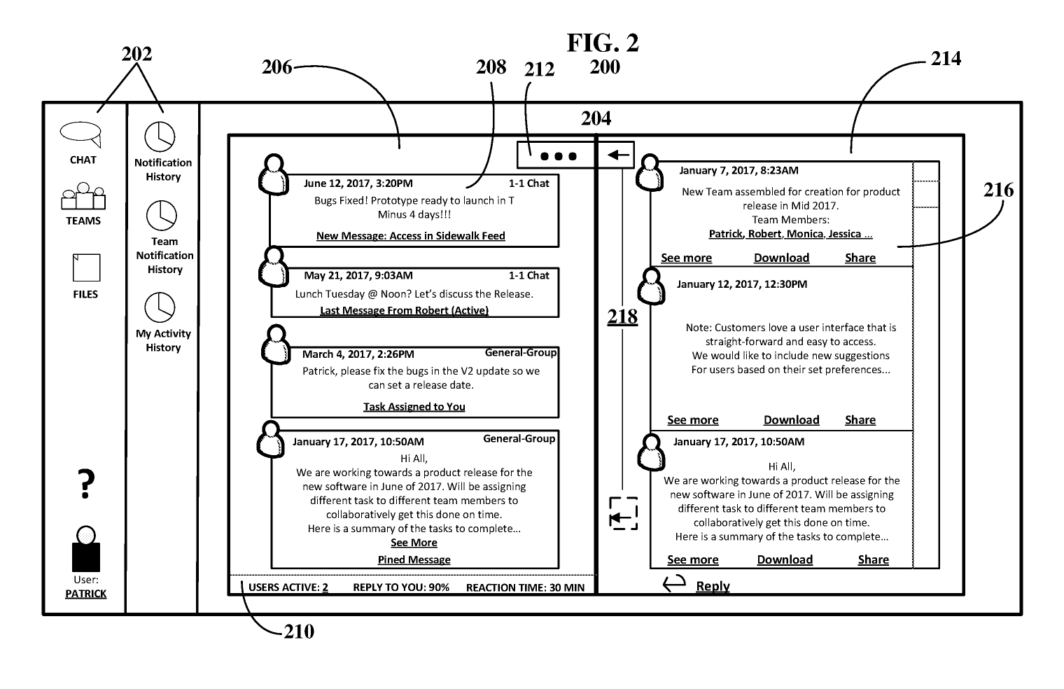

The dual feed may be displayed through a user interface of an exemplary application/service. A non-limiting illustrative example of an exemplary dual feed is presented in FIG. 2 (processing device view 200). An exemplary dual feed provides multiple feeds in a multi-column representation. A dual feed in a multi-column presentation provides technical advantages over a single column feed for a message thread. With a single column feed, a user can start participating directly from the feed but that causes the feed to be blocked in time and un able to be updated in real-time. For instance, with a single-column representation of a feed, a user may only receive an update after completing an action such as replying to a thread. In other instances of a single column feed, a notification of an update may be provided to a user but the user is not able to access content of the notification. In such instances, a contextual summary of notification is not provided until the user actually selects/focuses on the notification or moves to the new message content. Thus, with single-column feeds, it is easy for the user to lose its focal point by having everything moving while the user is reading something worthwhile or make it more difficult for a user to reply to a message. This limits a user experience/interaction with an application/service as well as leads to inefficiency for completing tasks/execution of processing operations.

In the present disclosure, the dual feed may be a multi-column feed (multi-row message feed, multi-window, etc.) for a message thread that may be displayed and managed through a user interface of an exemplary application. In examples where the dual feed is a multi-column message feed, the multi-column feed may comprise: a first column that provides a summary feed providing summary data associated with message content of the message thread and a second column that provides a sidewalk feed presenting an entire representation for message content of the message thread. A user interface may be configured to enable a user to provide replies to a message thread, for example, through a feed (e.g. sidewalk feed) associated with a message thread. The dual feed is also different from a single column feed because it continues to get updated continuously in real-time, displaying context of updates for the user. This is possible because the user interface is configured to allow the user to click on any feed message to have that message open on the side walk (e.g. the right column of the dual feed). When this occurs, the summary feed (e.g. the left column of the dual feed) keep getting updated while a position on the right side is maintained, allowing the user to read the whole thread. An exemplary sidewalk feed contains the initial message and replies even if the clicked message was only a reply. In this way, the user is in context of the whole message and replies. The sidewalk feed also allows the user to interact with the message thread, for example, like adding a message to the thread.

The summary feed is active and continuously changing with incoming new message content. An exemplary summary feed is used to provide a real-time representation for the message thread. For example, the summary feed may be configured to provide a summary of the context of information (e.g. summary data) within a message thread including real-time notification(s) for the message thread. Non-limiting examples of recent notifications may comprise: recent message content (e.g. most recently received message, most recent N number of messages, etc.), pinned/bookmarked message content, contextual updates relating to the message thread, users of the message thread, attached content, contextual suggestions (e.g. predictive content for user) based on analyzed context of a message thread and telemetric analysis associated with the message thread, etc. In examples, an exemplary user interface is configured to provide notice of an update to a message thread as well as context associated with the update. For instance, a preview of a most recent message is provided (e.g. N number of lines of content for the user to understand the subject of the message, priority of the message, context of a message, who the message is from, who the recipients are, when it was received, etc.).

In generating an exemplary summary feed, one or more components associated with an exemplary application may be configured to analyze context of an entire message thread. Analysis of context of a message thread may comprise applying one or more input understanding models in coordination with knowledge repositories (including data stores for user data associated with a collaborative team environment) and/or knowledge graphs to evaluate semantic understanding, subject/entities, etc. In one example, input understanding processing for contextual analysis of content of a message thread may be further executed by a web search engine service (e.g. Bing®) and/or an intelligent personal assistant service (e.g. Cortana®). Models, knowledge repositories and associated components for analysis of a message thread and input understanding processing are known to one skilled in the art. Communications across the message thread may be analyzed (e.g. telemetric analysis), where a user interface of an exemplary application/service may be configured to provide a real-time analytical representation of the message thread, for example, recent messages, active users, reply frequency, reply times, contextual analysis (e.g. topics, suggestions for the user), etc. As an example, the summary feed may comprise: data analytics for correspondence of the previous message data between users of the message thread. This may be useful to help a user identify reply patterns of another user, frequency of replies, what type of response to expect, etc.

In one example, data analytics provided in the summary feed may comprise an indication of a number of messages and replies based on interactions between users of the message thread. For example, a user may be able to see that another user of the message thread only replied 3 times on 20 messages or a rate of reply of that user responds to messages of another user. Other analytical information that may be displayed comprises information about the user (e.g. job title and who this one report to, bio information, etc.). Further, additional information that can be analyzed and displayed comprises: information as to when a user was last online, patterns of when the user is online/offline based on previous access, data showing the rate of user reply as well as data showing when a user typically replies (e.g. so a user may be able to expect a reply). For example, a data analytic, may be generated and presented in an exemplary real-time visualization, that highlights that a specific user replies to messaging user 82% of time. Also, other statistics like the median time that the user replies in specific instances such as when the user is mentioned in message thread. For example, “8 min” (i.e. representing that the user takes an average of 8 minutes to reply to a message they were mentioned in). However, it is to be understood that data analytics can be generated and presented for any type of related to correspondence between users (e.g. the normal rate of reply from a user across all types of communications). Additional analysis executed on previous message content is identification of one-on-one correspondence between the user and the mentioned user (or group of users). This can be helpful in assisting a user in determining how to reply and who to draft a reply too.

Furthermore, the summary feed is configured to move exiting messages back to the top when someone in the message thread replies to a message. In this way, the summary feed can maintain orderly presentation of message content as well as limit the entries that are displayed in the summary feed to avoid instances where the same message appears multiple times in the summary feed. For example, if there are messages in the feed “A”, then “B” and then “C”, the summary feed may show C-B-A (because of the time the message were added, and that because messages can be displayed newest to oldest). However, if the message “A” receives a reply, the entry “A” may be moved back to the top, which means that the summary feed now presented the message content in the order A-C-B. In one example, the summary feed may contain the message “A” and the reply but hide any other content associated with the Message “A” until the user accesses the full content in the sidewalk feed. It is to be understood that an exemplary user interface may be configured to enable a user to set rules or settings for display of content in a summary feed and/or sidewalk feed.

An exemplary sidewalk feed is simultaneously presented with the summary feed where the sidewalk feed is fixed in time and contains previous message content for a user to review in an uninterrupted manner. The sidewalk feed presents an entire representation of a message thread, for example, up to a given point in time. The sidewalk feed allows the user to read and/or interact (e.g. generate a reply) for the message thread without being interrupted with notifications or changes to the message thread. In one example, the entire representation of the message thread is presented in a read-only format. A user may have access to user interface features to assist with viewing content of the message thread, sharing content, generating responses, etc. but the actual message content presented in the entire representation may not be editable. In one instance, the message content in the sidewalk feed is presented in chronological order.

A user interface may be configured to provide user interface features that enable a user to rearrange content in the sidewalk feed, for example, the entire representation of the message thread. In one example, an exemplary sidewalk feed may not be automatically updated in real-time. For instance, if there is an update to the message content, the user may receive a notification in the summary feed, where the notification in the summary feed can be selected to trigger update to the sidewalk feed. In another example, a user may select a user interface feature associated with the sidewalk feed to trigger update of the message content (e.g. a refresh feature). In yet another example, a user interface feature may be presented that enables toggling of viewing of the sidewalk feed. For example, a user can select to hide the sidewalk feed from display, where re-displaying the sidewalk feed may trigger a refresh update to the entire representation of the message thread. In cases where a sidewalk feed is hidden from display (or launched/re-launched) the entire representation of the content may be refreshed up to a current point in time. In some examples, a dual feed may initially display both a summary feed and sidewalk feed and in other examples display of the dual feed may be toggled between a partial display (e.g. one feed) and a full multi-column display providing both feeds. Examples related to receiving of input to toggle display of the dual feed are provided in the subsequent description where display of a dual feed may be updated.

Once an exemplary dual feed is presented for a message thread, flow of method 100 may proceed to decision operation 108. At decision operation 108, it is determined whether a display of the dual feed is to be updated. As an example, the dual feed may be updated when an update is received to content of the message thread, by an action taken by a user or by the application/service on behalf of the user. For instance, the application/service may update the dual feed (e.g. the summary feed and/or the sidewalk feed) when new message content is received. In other examples, a user may interact with user interface features of the dual feed causing update to the dual feed. For instance, a user may provide an input through the user interface to interact with the dual feed of the message thread. Input may be received in any form including but not limited to: device input, audio input, handwritten input and touch input, among other examples. In examples where no update is received to the message thread, flow of method 100 may branch NO and processing remains idle. In examples where an update occurs to the message thread, flow of method 100 branches YES and processing proceeds to processing operation 110. At processing operation 110, the user interface of an exemplary application/service is updated to display an update to the dual feed for the message thread. Examples of received input and update to the dual feed are now provided.

In one example, a user may provide input, into the summary feed (e.g. first column) to select a real-time notification. The input may be received and processed, resulting in update (processing operation 110) of display of the sidewalk feed (e.g. second column), for example, where display of the sidewalk feed is updated to display the specific message content that is associated with the real-time notification. For instance, the sidewalk feed may display message content of the message thread in chronological order beginning from an originating message. A selection of a specific real-time notification (e.g. in the summary feed) may trigger the user interface to automatically update the sidewalk feed to a position for message content associated with the real-time notification even when that message content is not initially displayed.

In some examples, the sidewalk feed is not initially displayed when the message feed is presented. For instance, a summary feed is initially presented that comprises a user interface feature to expand a view of dual feed to a full multi-column feed. For instance, an exemplary application may receive, through the user interface, a selection of a user interface feature to expand a view of the multi-column feed. In that instance, the user interface is configured to display a second-column of the dual feed (for the sidewalk feed) based on the selection of the user interface feature to expand the view of the dual feed. In one example, the user interface feature to expand a view of the dual feed is an ellipsis icon, for example as shown FIG. 2 (e.g. user interface feature 212 and corresponding with user interface feature 218). However, it is to be understood that presentation of a user interfaced feature for toggling display of the dual feed may vary without departing from the spirit of the present disclosure.

In another example, a user may provide input, into the sidewalk feed (e.g. second column) to scroll through a portion of the entire representation of the message thread. The input may be received and processed, resulting in update (processing operation 110) of display of the sidewalk feed (e.g. second column), for example, where a position of the message thread is updated to a position that is associated with the received input. In such an instance, the user interface is configured to maintain the position in the sidewalk feed (e.g. second column), in which the user scrolled to, when the display of the summary feed (e.g. first column) is updated, for example, based on a real-time notification.

In yet another example, an application, through the user interface, may receive a selection of a user interface feature to provide a reply to the message thread. In examples, a user interface feature to initiate reply to a message thread may be presented in the sidewalk feed (e.g. second column of the dual feed). The user interface is configured to focus display of the sidewalk feed at a position for a user to enter a draft reply to the message thread. In examples, the position for entry of the draft reply is maintained while the summary feed (e.g. first column of the dual feed) is simultaneously updated, for example, based on a real-time notification.

In some alternative examples, display of the dual feed for the message thread may be hidden from view based on a predetermined period of inactivity (e.g. idle time) or selection of other user interface features (e.g. application command control that navigates a user away from a message thread) within an application. In at least one example, when a user selects to re-display the dual feed, the application is configured to provide the dual feed where a last accessed position (e.g. in a sidewalk feed) is maintained for the user. In other alternative examples, the dual feed is configured to display outside of a main application window of an exemplary application/service, for example, where the dual feed may be presented in association with an operating system (OS) of a computing device or accessible through other streams of data presented on a computing device.

FIG. 2 illustrates a non-limiting processing device view 200 of an exemplary dual feed for a message thread with which aspects of the present disclosure may be practiced. Processing device view 200 provides a user interface of an exemplary application (e.g. collaborative team environment) that comprises application command control features 202 to manage application content including display of message threads and feeds. Further, processing device view 200 displays a main application window 204 for an exemplary application, which is configured to display an exemplary dual feed for a message thread. Description for features and user interface examples for an exemplary dual feed have been provided in the foregoing description of method 100 (FIG. 1).

As can be seen in processing device view 200, the main application window 204 displays a multi-column feed for a message thread that comprises a summary feed 206 and a sidewalk feed 214. An exemplary summary feed 206 may be configured to provide a summary of the context of information within a message thread including recent notification(s) of the message thread. As an example, the summary feed 206 may be configured to show a summary of specific message content, for example, including an indication as to why the content is included in the summary feed 206. For instance, a real-time notification may be provided for most recent message content, a most recent communication from a user that is active in the message thread, tasks/reminders, content with acknowledgement (e.g. likes, mentions, tweets, re-tweets, etc.), and pinned/bookmarked message content, among other examples. Furthermore, in some examples, the summary feed 206 may comprise output of data analytics 210 for a message thread, which may assist a user with management of a message thread. For instance, data analytics 210 presented in summary feed 206 comprise but are not limited to: an indication of active users, an indication of reply rate of uses associated with the message thread and reaction time for replying, among other examples. The summary feed 206 is active and continuously changing with incoming new message content. For example, if a content update occurs to a message thread, the summary feed 206 may be updated in real-time.

An exemplary sidewalk feed 214 is simultaneously presented with the summary feed where the sidewalk feed is fixed in time and contains previous message content for a user to review in an uninterrupted manner. The sidewalk feed allows the user to read and/or interact (e.g. generate a reply) for the message thread without being interrupted with notifications or changes to the message thread. The sidewalk feed 214 may comprise message content 216 associated with the message thread. As described in the foregoing, the sidewalk feed 214 is configured to present an entire representation of message content 216 in the message thread, for example, where the message content 216 is presented in chronological order for the user.

The summary feed 206 may further be configured to provide a user interface feature 212 to expand a view of the dual feed. For instance, selection of a user interface feature 212 (e.g. ellipsis icon) may trigger expansion of the dual feed that displays exemplary sidewalk feed 214. The dual feed may further comprise a user interface feature 218 to control display of the sidewalk feed 214. For instance, a user can select user interface feature 218 to collapse a dual message feed and hide the sidewalk feed 214 from view. In one example, user interface feature 218 may be displayed, within the sidewalk feed 214, at a position of specific message content. For instance, the user interface may be configured to display user interface feature 218 at a scrolling position within the message thread of the sidewalk feed 214. In another instance, a user may select a real-time notification in the summary feed 206, which may trigger update of the sidewalk feed 214 to a position of message content associated with the real-time notification. In such an instance, the user interface is configured to display user interface feature 218 at a positon for that specific message content.

FIGS. 3-5 and the associated descriptions provide a discussion of a variety of operating environments in which examples of the invention may be practiced. However, the devices and systems illustrated and discussed with respect to FIGS. 3-5 are for purposes of example and illustration and are not limiting of a vast number of computing device configurations that may be utilized for practicing examples of the invention, described herein.

FIG. 3 is a block diagram illustrating physical components of a computing device 302, for example a mobile processing device, with which examples of the present disclosure may be practiced. Among other examples, computing device 302 may be an exemplary computing device configured for display and management of an exemplary dual feed for a message thread as described herein. In a basic configuration, the computing device 302 may include at least one processing unit 304 and a system memory 306. Depending on the configuration and type of computing device, the system memory 306 may comprise, but is not limited to, volatile storage (e.g., random access memory), non-volatile storage (e.g., read-only memory), flash memory, or any combination of such memories. The system memory 306 may include an operating system 307 and one or more program modules 308 suitable for running software programs/modules 320 such as IO manager 324, other utility 326 and application 328. As examples, system memory 306 may store instructions for execution. Other examples of system memory 306 may store data associated with applications. The operating system 307, for example, may be suitable for controlling the operation of the computing device 302. Furthermore, examples of the invention may be practiced in conjunction with a graphics library, other operating systems, or any other application program and is not limited to any particular application or system. This basic configuration is illustrated in FIG. 3 by those components within a dashed line 322. The computing device 302 may have additional features or functionality. For example, the computing device 302 may also include additional data storage devices (removable and/or non-removable) such as, for example, magnetic disks, optical disks, or tape. Such additional storage is illustrated in FIG. 3 by a removable storage device 309 and a non-removable storage device 310.

As stated above, a number of program modules and data files may be stored in the system memory 306. While executing on the processing unit 304, program modules 308 (e.g., Input/Output (I/O) manager 324, other utility 326 and application 328) may perform processes including, but not limited to, one or more of the stages of the operations described throughout this disclosure. Other program modules that may be used in accordance with examples of the present invention may include electronic mail and contacts applications, word processing applications, spreadsheet applications, database applications, slide presentation applications, drawing or computer-aided application programs, photo editing applications, authoring applications, etc.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 3 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the computing device 402 on the single integrated circuit (chip). Examples of the present disclosure may also be practiced using other technologies capable of performing logical operations such as, for example, AND, OR, and NOT, including but not limited to mechanical, optical, fluidic, and quantum technologies. In addition, examples of the invention may be practiced within a general purpose computer or in any other circuits or systems.

The computing device 302 may also have one or more input device(s) 312 such as a keyboard, a mouse, a pen, a sound input device, a device for voice input/recognition, a touch input device, etc. The output device(s) 314 such as a display, speakers, a printer, etc. may also be included. The aforementioned devices are examples and others may be used. The computing device 302 may include one or more communication connections 316 allowing communications with other computing devices 318. Examples of suitable communication connections 316 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 306, the removable storage device 309, and the non-removable storage device 310 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 302. Any such computer storage media may be part of the computing device 302. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

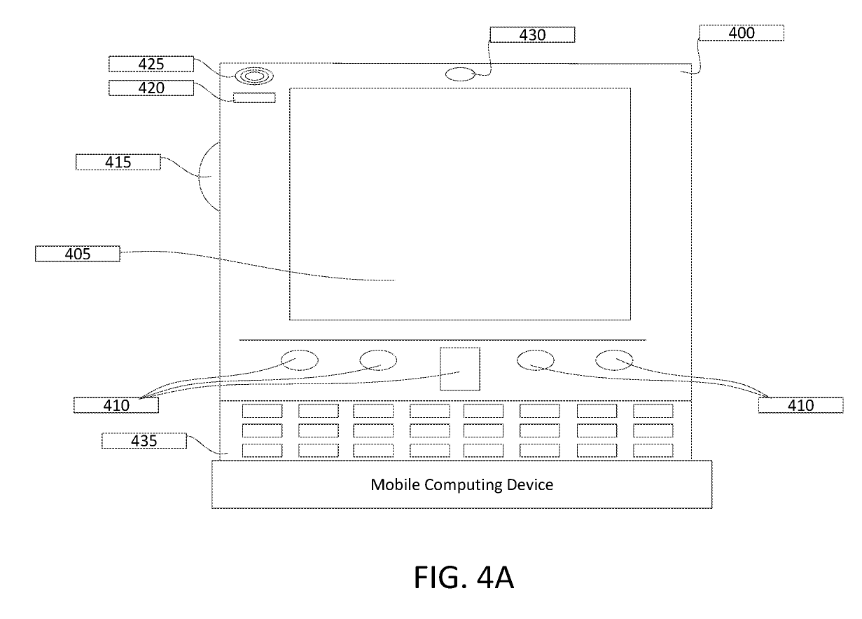

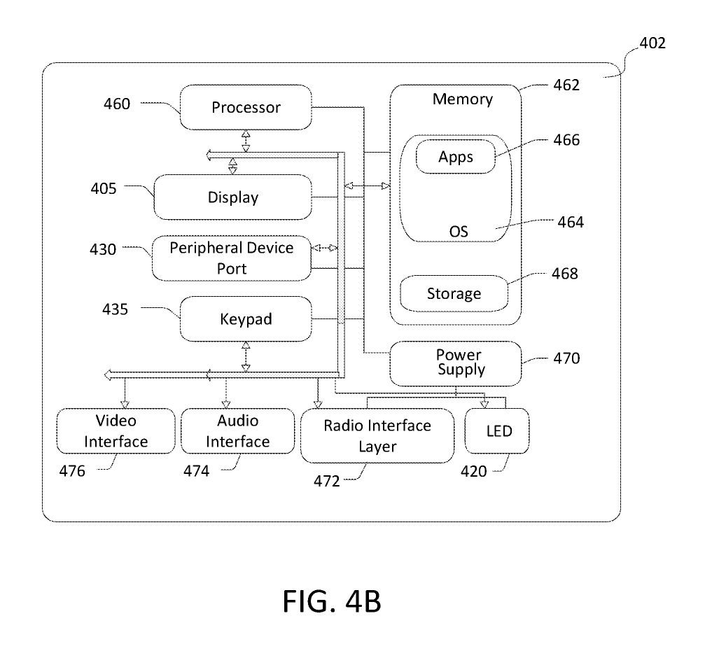

FIGS. 4A and 4B illustrate a mobile computing device 400, for example, a mobile telephone, a smart phone, a personal data assistant, a tablet personal computer, a phablet, a slate, a laptop computer, and the like, with which examples of the invention may be practiced. Mobile computing device 400 may be an exemplary computing device configured for display and management of an exemplary dual feed for a message thread as described herein. Application command control may be provided for applications executing on a computing device such as mobile computing device 400. Application command control relates to presentation and control of commands for use with an application through a user interface (UI) or graphical user interface (GUI). In one example, application command controls may be programmed specifically to work with a single application. In other examples, application command controls may be programmed to work across more than one application. With reference to FIG. 4A, one example of a mobile computing device 400 for implementing the examples is illustrated. In a basic configuration, the mobile computing device 400 is a handheld computer having both input elements and output elements. The mobile computing device 400 typically includes a display 405 and one or more input buttons 410 that allow the user to enter information into the mobile computing device 400. The display 405 of the mobile computing device 400 may also function as an input device (e.g., touch screen display). If included, an optional side input element 415 allows further user input. The side input element 415 may be a rotary switch, a button, or any other type of manual input element. In alternative examples, mobile computing device 400 may incorporate more or less input elements. For example, the display 405 may not be a touch screen in some examples. In yet another alternative example, the mobile computing device 400 is a portable phone system, such as a cellular phone. The mobile computing device 400 may also include an optional keypad 435. Optional keypad 435 may be a physical keypad or a “soft” keypad generated on the touch screen display or any other soft input panel (SIP). In various examples, the output elements include the display 405 for showing a GUI, a visual indicator 420 (e.g., a light emitting diode), and/or an audio transducer 425 (e.g., a speaker). In some examples, the mobile computing device 400 incorporates a vibration transducer for providing the user with tactile feedback. In yet another example, the mobile computing device 400 incorporates input and/or output ports, such as an audio input (e.g., a microphone jack), an audio output (e.g., a headphone jack), and a video output (e.g., a HDMI port) for sending signals to or receiving signals from an external device.

FIG. 4B is a block diagram illustrating the architecture of one example of a mobile computing device. That is, the mobile computing device 400 can incorporate a system (i.e., an architecture) 402 to implement some examples. In one examples, the system 402 is implemented as a “smart phone” capable of running one or more applications (e.g., browser, e-mail, calendaring, contact managers, messaging clients, games, and media clients/players). In some examples, the system 402 is integrated as a computing device, such as an integrated personal digital assistant (PDA), tablet and wireless phone.

One or more application programs 466 may be loaded into the memory 462 and run on or in association with the operating system 464. Examples of the application programs include phone dialer programs, e-mail programs, personal information management (PIM) programs, word processing programs, spreadsheet programs, Internet browser programs, messaging programs, and so forth. The system 402 also includes a non-volatile storage area 468 within the memory 462. The non-volatile storage area 468 may be used to store persistent information that should not be lost if the system 402 is powered down. The application programs 466 may use and store information in the non-volatile storage area 468, such as e-mail or other messages used by an e-mail application, and the like. A synchronization application (not shown) also resides on the system 402 and is programmed to interact with a corresponding synchronization application resident on a host computer to keep the information stored in the non-volatile storage area 468 synchronized with corresponding information stored at the host computer. As should be appreciated, other applications may be loaded into the memory 462 and run on the mobile computing device (e.g. system 402) described herein.

The system 402 has a power supply 470, which may be implemented as one or more batteries. The power supply 470 might further include an external power source, such as an AC adapter or a powered docking cradle that supplements or recharges the batteries.

The system 402 may include peripheral device port 430 that performs the function of facilitating connectivity between system 402 and one or more peripheral devices. Transmissions to and from the peripheral device port 430 are conducted under control of the operating system (OS) 464. In other words, communications received by the peripheral device port 430 may be disseminated to the application programs 466 via the operating system 464, and vice versa.

The system 402 may also include a radio interface layer 472 that performs the function of transmitting and receiving radio frequency communications. The radio interface layer 472 facilitates wireless connectivity between the system 402 and the “outside world,” via a communications carrier or service provider. Transmissions to and from the radio interface layer 472 are conducted under control of the operating system 464. In other words, communications received by the radio interface layer 472 may be disseminated to the application programs 566 via the operating system 464, and vice versa.

The visual indicator 420 may be used to provide visual notifications, and/or an audio interface 474 may be used for producing audible notifications via the audio transducer 425 (as described in the description of mobile computing device 400). In the illustrated example, the visual indicator 420 is a light emitting diode (LED) and the audio transducer 425 is a speaker. These devices may be directly coupled to the power supply 470 so that when activated, they remain on for a duration dictated by the notification mechanism even though the processor 460 and other components might shut down for conserving battery power. The LED may be programmed to remain on indefinitely until the user takes action to indicate the powered-on status of the device. The audio interface 474 is used to provide audible signals to and receive audible signals from the user. For example, in addition to being coupled to the audio transducer 425 (shown in FIG. 4A), the audio interface 474 may also be coupled to a microphone to receive audible input, such as to facilitate a telephone conversation. In accordance with examples of the present invention, the microphone may also serve as an audio sensor to facilitate control of notifications, as will be described below. The system 402 may further include a video interface 476 that enables an operation of an on-board camera 430 to record still images, video stream, and the like.

A mobile computing device 400 implementing the system 402 may have additional features or functionality. For example, the mobile computing device 400 may also include additional data storage devices (removable and/or non-removable) such as, magnetic disks, optical disks, or tape. Such additional storage is illustrated in FIG. 4B by the non-volatile storage area 468.

Data/information generated or captured by the mobile computing device 400 and stored via the system 402 may be stored locally on the mobile computing device 400, as described above, or the data may be stored on any number of storage media that may be accessed by the device via the radio 472 or via a wired connection between the mobile computing device 400 and a separate computing device associated with the mobile computing device 400, for example, a server computer in a distributed computing network, such as the Internet. As should be appreciated such data/information may be accessed via the mobile computing device 400 via the radio 472 or via a distributed computing network. Similarly, such data/information may be readily transferred between computing devices for storage and use according to well-known data/information transfer and storage means, including electronic mail and collaborative data/information sharing systems.

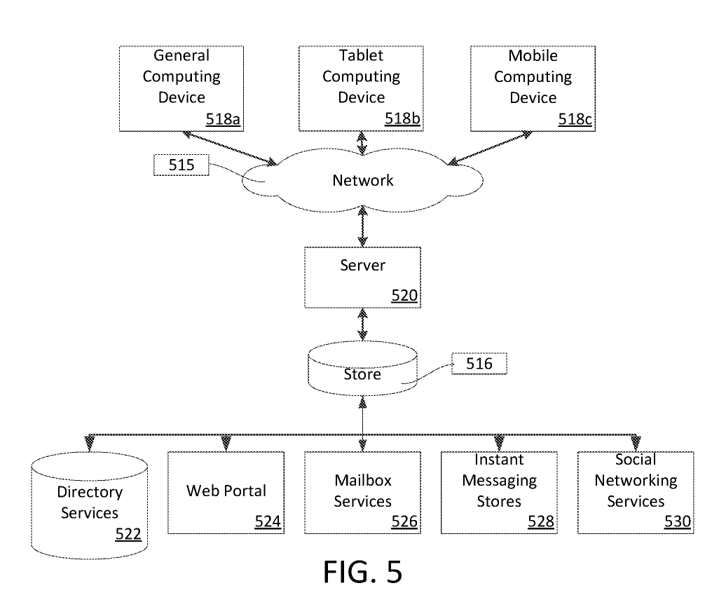

FIG. 5 illustrates one example of the architecture of a system for providing an application that reliably accesses target data on a storage system and handles communication failures to one or more client devices, as described above. The system of FIG. 5 may be an exemplary system configured for display and management of an exemplary dual feed for a message thread as described herein. Target data accessed, interacted with, or edited in association with programming modules 308 and/or applications 320 and storage/memory (described in FIG. 3) may be stored in different communication channels or other storage types. For example, various documents may be stored using a directory service 522, a web portal 524, a mailbox service 526, an instant messaging store 528, or a social networking site 530, IO manager 324, other utility 326, application 328 and storage systems may use any of these types of systems or the like for enabling data utilization, as described herein. A server 520 may provide storage system for use by a client operating on general computing device 302 and mobile device(s) 400 through network 515. By way of example, network 515 may comprise the Internet or any other type of local or wide area network, and a client node may be implemented for connecting to network 515. Examples of a client node comprise but are not limited to: a computing device 302 embodied in a personal computer, a tablet computing device, and/or by a mobile computing device 400 (e.g., mobile processing device). As an example, a client node may connect to the network 515 using a wireless network connection (e.g. WiFi connection, Bluetooth, etc.). However, examples described herein may also extend to connecting to network 515 via a hardwire connection. Any of these examples of the client computing device 302 or 400 may obtain content from the store 516.

Reference has been made throughout this specification to “one example” or “an example,” meaning that a particular described feature, structure, or characteristic is included in at least one example. Thus, usage of such phrases may refer to more than just one example. Furthermore, the described features, structures, or characteristics may be combined in any suitable manner in one or more examples.

One skilled in the relevant art may recognize, however, that the examples may be practiced without one or more of the specific details, or with other methods, resources, materials, etc. In other instances, well known structures, resources, or operations have not been shown or described in detail merely to observe obscuring aspects of the examples.

While sample examples and applications have been illustrated and described, it is to be understood that the examples are not limited to the precise configuration and resources described above. Various modifications, changes, and variations apparent to those skilled in the art may be made in the arrangement, operation, and details of the methods and systems disclosed herein without departing from the scope of the claimed examples.

What is claimed is:

1. A method comprising:
receiving, through a user interface of an application, a selection of a message thread;
in response to the selection, displaying, through the user interface, a multi-column feed for the message thread, wherein the multi-column feed comprises:
a first column that provides a summary feed providing summary data associated with message content of the message thread, and
a second column that provides a sidewalk feed presenting an entire representation for message content of the message thread;
receiving an update to the message thread; and
updating, through the user interface, a display of the first column of the multi-column feed to present a real-time notification of the update.

2. The method of claim 1, wherein the entire representation of the message thread, displayed in the second column, is read-only.

3. The method of claim 1, further comprising: receiving, in the second column of the multi-column feed, an input to scroll through a portion of the entire representation of the message thread, and updating display of the second column to a position of the message thread based on the received input, wherein the position in the second column is maintained for the user when the display of the first column is updated based on the real-time notification.

4. The method of claim 1, wherein the message content in the sidewalk feed is presented in chronological order.

5. The method of claim 4, further comprising: receiving, in the first column of the multi-column feed, a selection of the real-time notification, and updating display of the sidewalk feed to specific message content that is associated with the real-time notification.

6. The method of claim 1, further comprising: receiving a selection of a user interface feature to expand a view of the multi-column feed, wherein the second column is initially hidden from display and is displayed based on the selection of the user interface feature to expand the view of the multi-column feed.

7. The method of claim 1, further comprising: receiving, in the second column, a selection of a user interface feature to provide a reply to the message thread, focusing display of the sidewalk feed at a position for a user to enter a draft reply to the message thread, wherein the position for entry of the draft reply is maintained while the first column is simultaneously updated based on the real-time notification.

8. A system comprising:
at least one processor; and
a memory, operatively connected with the at least one processor, storing computer-executable instructions that, when executed by the at least one processor, causes the at least one processor to execute a method that comprises:
receiving, through a user interface of an application, a selection of a message thread;
in response to the selection, displaying, through the user interface, a multi-column feed for the message thread, wherein the multi-column feed comprises:
a first column that provides a summary feed providing summary data associated with message content of the message thread, and
a second column that provides a sidewalk feed presenting an entire representation for message content of the message thread;
receiving an update to the message thread; and
updating, through the user interface, a display of the first column of the multi-column feed to present a real-time notification of the update.

9. The system of claim 8, wherein the entire representation of the message thread, displayed in the second column, is read-only.

10. The system of claim 8, wherein the method, executed by the at least one processor, further comprises: receiving, in the second column of the multi-column feed, an input to scroll through a portion of the entire representation of the message thread, and updating display of the second column to a position of the message thread based on the received input, wherein the position in the second column is maintained for the user when the display of the first column is updated based on the real-time notification.

11. The system of claim 8, wherein the message content in the sidewalk feed is presented in chronological order.

12. The system of claim 11, wherein the method, executed by the at least one processor, further comprises: receiving, in the first column of the multi-column feed, a selection of the real-time notification, and updating display of the sidewalk feed to specific message content that is associated with the real-time notification.

13. The system of claim 8, wherein the method, executed by the at least one processor, further comprises: receiving a selection of a user interface feature to expand a view of the multi-column feed, wherein the second column is initially hidden from display and is displayed based on the selection of the user interface feature to expand the view of the multi-column feed.

14. The system of claim 8, wherein the method, executed by the at least one processor, further comprises: receiving, in the second column, a selection of a user interface feature to provide a reply to the message thread, focusing display of the sidewalk feed at a position for a user to enter a draft reply to the message thread, wherein the position for entry of the draft reply is maintained while the first column is simultaneously updated based on the real-time notification.

15. A computer-readable medium storing computer-executable instructions that, when executed by at least one processor, causes the at least one processor to execute a method comprising:
receiving, through a user interface of an application, a selection of a message thread;
in response to the selection, displaying, through the user interface, a multi-column feed for the message thread, wherein the multi-column feed comprises:
a first column that provides a summary feed providing summary data associated with message content of the message thread, and
a second column that provides a sidewalk feed presenting an entire representation for message content of the message thread;
receiving an update to the message thread; and
updating, through the user interface, a display of the first column of the multi-column feed to present a real-time notification of the update.

16. The computer-readable medium of claim 15, wherein the entire representation of the message thread, displayed in the second column, is read-only.

17. The computer-readable medium of claim 15, wherein the executed method further comprising: receiving, in the second column of the multi-column feed, an input to scroll through a portion of the entire representation of the message thread, and updating display of the second column to a position of the message thread based on the received input, wherein the position in the second column is maintained for the user when the display of the first column is updated based on the real-time notification.

18. The computer-readable medium of claim 15, wherein the executed method further comprising: receiving, in the first column of the multi-column feed, a selection of the real-time notification, and updating display of the sidewalk feed to specific message content that is associated with the real-time notification.

19. The computer-readable medium of claim 15, wherein the executed method further comprising: receiving a selection of a user interface feature to expand a view of the multi-column feed, wherein the second column is initially hidden from display and is displayed based on the selection of the user interface feature to expand the view of the multi-column feed.

20. The computer-readable medium of claim 15, wherein the executed method further comprising: receiving, in the second column, a selection of a user interface feature to provide a reply to the message thread, focusing display of the sidewalk feed at a position for a user to enter a draft reply to the message thread, wherein the position for entry of the draft reply is maintained while the first column is simultaneously updated based on the real-time notification.
